(19) United States
(12) Patent Application Publication
(10) Pub. No.: US 2014/0344276 A1
(43) Pub. Date: Nov. 20, 2014

(54) Method and System for Generating Evaluation Information, and Computer Storage Medium

(71) Applicant: TENCENT TECHNOLOGY (SHENZHEN) COMPANY, Shenzhen (CN)

(72) Inventors: Min Wei, Shenzhen (CN); Tian Yin, Shenzhen (CN); Shang Yu, Shenzhen (CN); Xi Wan, Shenzhen (CN); Huili Zhang, Shenzhen (CN)

(21) Appl. No.: 14/367,430

(22) PCT Filed: Dec. 12, 2012
(86) PCT No.: PCT/CN2012/086465

§ 371 Date: Jun. 20, 2014

(30) Foreign Application Priority Data
Dec. 28, 2011 (CN) 201110447900.7

(51) Int. Cl. G06F 17/30

(52) U.S. Cl. CPC G06F 17/30598
USPC 707/737

(57) ABSTRACT

A method for generating evaluation information, including the following steps: obtaining first information from user behavior information; determining whether the first information matches key matching information, and if yes, then obtaining a category to which the key matching information corresponding to the first information belongs; and generating evaluation information according to the category. The method and system for providing evaluation information, and a corresponding computer storage medium, obtain first information from the user behavior information, and obtain a corresponding category according to the first information which matches the preset key matching information, thus generating evaluation information corresponding to the category. The generated evaluation information varies as the first information varies, and dynamic adjustment of evaluation information is achieved.

### TECHNICAL FIELD

The present invention relates to information processing technologies, and particularly relates to a method and system for generating evaluation information, and a computer storage medium.

### BACKGROUND

In social networks, for example, in social contacts by using an instant messaging tool, a user can obtain evaluation information that his friends make on him by viewing his data, the evaluation information coming from his friends' subjective evaluations on the user, and he can also obtain evaluation information on a friend by viewing the friend's data, the evaluation information on the friend coming from other peoples' subjective evaluations on the friend, which often reflects hobbies and evaluations of the user or the friend. This kind of evaluation information tends to be fixed in the user's data or in the friend's data, only decreases as the user deletes evaluation information, and increases as the user adds new evaluation information, which depends on the operations of the user and his friend, and can't realize dynamic adjustments to the evaluation information.

### SUMMARY

It is necessary to provide a method for generating evaluation information to dynamically adjust evaluation information.

In addition, it is necessary to provide a system for generating evaluation information to dynamically adjust evaluation information.

Furthermore, it is necessary to provide a computer storage medium to dynamically adjust evaluation information.

A method for generating evaluation information includes the following steps:

obtaining first information from user behavior information;

determining whether the first information matches key matching information, and if yes, then obtaining a category to which the key matching information corresponding to the first information belongs; and

generating evaluation information according to the category.

A system for generating evaluation information includes:

an information obtaining module, to obtain first information from user behavior information;

a key matching information determination module, to determine whether the first information matches key match information, and if yes, to notify a category processing module;

the category processing module, to obtain a category to which the key matching information corresponding to the first information belongs; and

an evaluation information generation module, to generate evaluation information according to the category.

A computer storage medium stores computer executable instructions. The computer executable instructions control a computer to implement a method for providing evaluation information, in which the method includes:

obtaining first information from user behavior information;

determining whether the first information matches key matching information, and if yes, then obtaining a category to which the key matching information corresponding to the first information belongs; and

generating evaluation information according to the category.

The method and system for providing evaluation information, and a corresponding computer storage medium, obtain first information from user behavior information, and obtain a corresponding category according to the first information that matches the preset key matching information, thus generating evaluation information corresponding to the category. The generated evaluation information varies as the first information varies, and dynamic adjustment of evaluation information is achieved.

### BRIEF DESCRIPTION OF THE DRAWINGS

FIG. 1 shows a flow chart of a method for generating evaluation information according to an example;

FIG. 2 shows a flow chart of a method for generating evaluation information according to another example;

FIG. 3 shows a flow chart of a method for obtaining a category to which key matching information corresponding to first information belongs according to an example;

FIG. 4 shows a flow chart of a method for obtaining a category to which the first information belongs from a mapping relation between the first information and the category and counting the occurrence frequency of the category according to an example;

FIG. 5 shows a schematic diagram of a category hierarchy of categories according to an example;

FIG. 6 shows a flow chart of a method for obtaining the category to which the first information belongs from the mapping relation between the first information and the categories and counting the occurrence frequency of the category according to another example;

FIG. 7 shows a flow chart of a method for generating evaluation information according to the category according to an example;

FIG. 8 shows a schematic diagram of occurrence frequencies and mapping relations of a sports category according to an example;

FIG. 9 shows a schematic diagram of occurrence frequencies and mapping relations of a music category according to an example;

FIG. 10 shows a schematic diagram of occurrence frequencies and mapping relation of a book category according to an example;

FIG. 11 shows a structural schematic diagram of a system for generating evaluation information according to an example;

FIG. 12 shows a structural schematic diagram of a system for generating evaluation information according to another example;

FIG. 13 shows a structural schematic diagram of a category processing module according to an example; and

FIG. 14 shows a structural schematic diagram of an evaluation information generation module according to an example.

### DETAILED DESCRIPTION

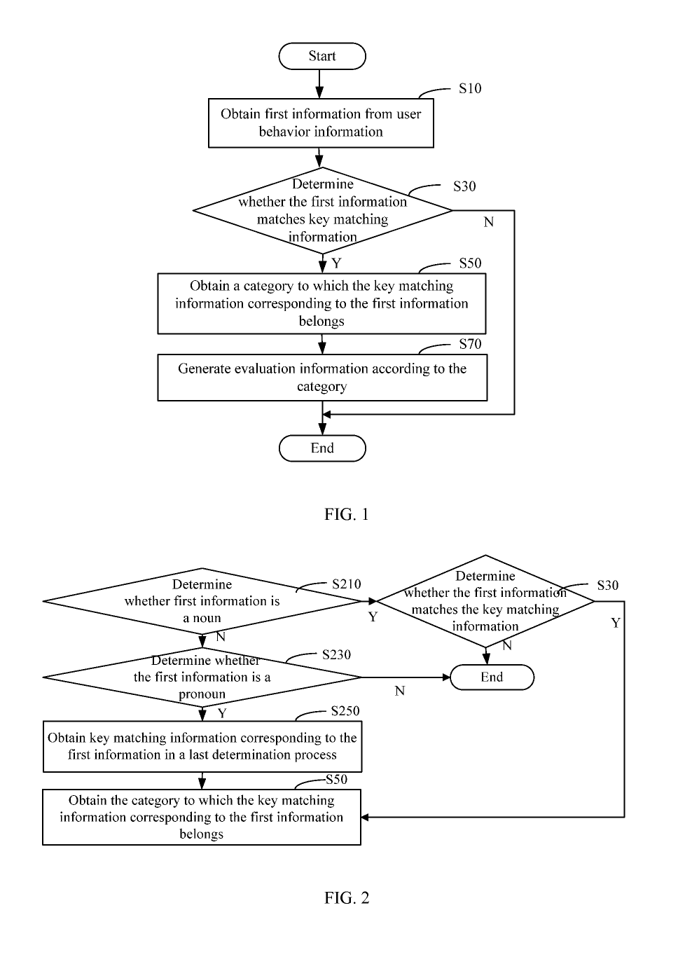

As shown in FIG. 1, in an example, a method for generating evaluation information includes the following process.

At block 510, first information is obtained from user behavior information.

In the example, the user behavior information may be session contents generated during sessions by using a social network tool such as an instant messaging tool, i.e., chatting records, or may be information in websites such as blogs, microblogs, virtual communities, etc. Specifically, the user behavior information can be represented in the forms of text, pictures, and expressions used by users and the like. The first information may be a part or all of contents in the user behavior information. For example, if the user behavior information is in the form of text, the first information can be phrases in the user behavior information. If the user behavior information is picture information generated by an instant messaging tool in a session process, the first information can be an identification number corresponding to the picture information or other forms of identifications.

In an example, the user behavior information is text information, and the detailed process in the above block S110 is as follows: reading the user behavior information, and performing word segmentation for the user behavior information to obtain the first information.

In the present example, the text information may be phrases, or may be multiple paragraphs of text consisting of a plurality of phrases. Therefore, in order to make analysis of the text information, the word segmentation needs to be performed for the text information that has been read, and the result obtained by the word segmentation is the first information. Specifically, the first information may be a single phrase, or may also be various nouns, pronouns and so on in the text information that has been read.

At block S30, it is determined whether the first information matches key matching information. And if yes, then block S50 is entered, or otherwise, the process ends.

In the example, a plurality of key matching information is stored, so that certain key matching information that matches the first information can be found from the stored plurality of key matching information. For example, the key matching information may be a keyword, and may also be an identification number of a picture.

In an example, the user behavior information is text information and according to FIG. 2, before block S30, the method further includes the following process.

At block S210, it is determined whether the first information is a noun. If yes, then block S30 is entered, or otherwise, block S230 is entered.

In the present example, in the scenario that the user behavior information is text information, it is determined whether the first information obtained by the word segmentation process is a noun, and if the first information is a noun, then it is further determined whether the first information matches preset key matching information. If the first information is a certain keyword in the key matching information, it means that the first information is valid information and can be used to dynamically adjust the evaluation information.

At block S230, it is determined whether the first information is a pronoun, and if yes, then block S250 is entered, or otherwise, the process ends.

In the present example, if it is determined that the first information is not a noun, then it is further determined whether the first information is a pronoun and which first information in the user behavior information that the pronoun refers to. Further the determined first information is used for subsequent processes. If the pronoun does not refer to any first information in the user behavior information, then the process for the first information ends, and a process for another first information in the user behavior information is entered, or if the first information is the last first information in the user behavior information, the process for the user behavior information will end, and other user behavior information will be processed accordingly, the detailed process of which will not be elaborated herein.

At block S250, the key matching information corresponding to the first information in the last determination process is obtained, and block S50 is entered.

In the present example, in the scenario that it is determined that the first information is a pronoun, the key matching information that conforms to the first information in the last determination process for the first information is obtained, and block S50 is entered to obtain a category to which the key matching information belongs.

At block S50, the category to which the key matching information corresponding to the first information belongs is obtained.

In the present example, mapping relations between key matching information and categories are established in advance. After the key matching information corresponding to the first information is obtained, the category corresponding to the key matching information is obtained according to the established mapping relations. Specifically, the mapping relations between the key matching information and the categories can be in the form of data dictionary, and a data structure corresponding thereto can be a mapping table with form of expression as map<key, value>, in which each key value has a uniquely corresponding value, key matching information is a key value, and a category is a value.

At block S70, evaluation information is generated according to the category.

In the present example, according to a category corresponding to each piece of the first information in the user behavior information, evaluation information corresponding to the category can be obtained. That is, the evaluation information corresponding to the user behavior information varies as the contents in the user behavior information vary. Thus, through processing user behavior information generated in a session by using an instant messaging tool or through processing user behavior information generated in a website such as a virtual network community, dynamic change of evaluation information is achieved to accurately reflect current user behavior information. Specifically, the evaluation information, which is generated according to the category to which the first information in the user behavior information belongs, can be used to reflect interests and hobbies, hotspot information, moods and the like of the user or of the friend.

After the evaluation information is generated, the evaluation information may also be shown in the data of a corresponding user and in a virtual community website where the user is, in order to accurately reflect real characteristics of the user.

In an example, before the above block S30, the process further includes: establishing a mapping relation between an information abstract value and a storage address of the key matching information.

In the example, the storage address is an address where the key matching information is in a data dictionary, and it may be in the form of a memory address, such as 0X12345678, so as to perform searching in the key matching information according to the first information rapidly. The information abstract value of the key matching information can be a hash value calculated in text information through md5 (Message-Digest Algorithm 5), SHA (Secure Hash Algorithm) or other algorithms, and may also be an identification number in picture information. In the mapping relation between the information abstract value and the storage address of the key matching information, the corresponding mapping table structure can be such that the key matching information is a key value, while the storage address is a value.

The specific process of the above block S30 includes: searching in the mapping relation between the information abstract value and the memory address of the key matching information, determining whether the information abstract value corresponding to the first information exists in the information abstract value of the key matching information, and if yes, entering block S50, or if not, ending the process.

In the present example, the information abstract value of the first information is obtained, and search is performed in the mapping relation between the information abstract value and the storage address of the key matching information to find out an information abstract value of the key matching information that is the same with the information abstract value of the first information to further obtain the storage address corresponding thereto.

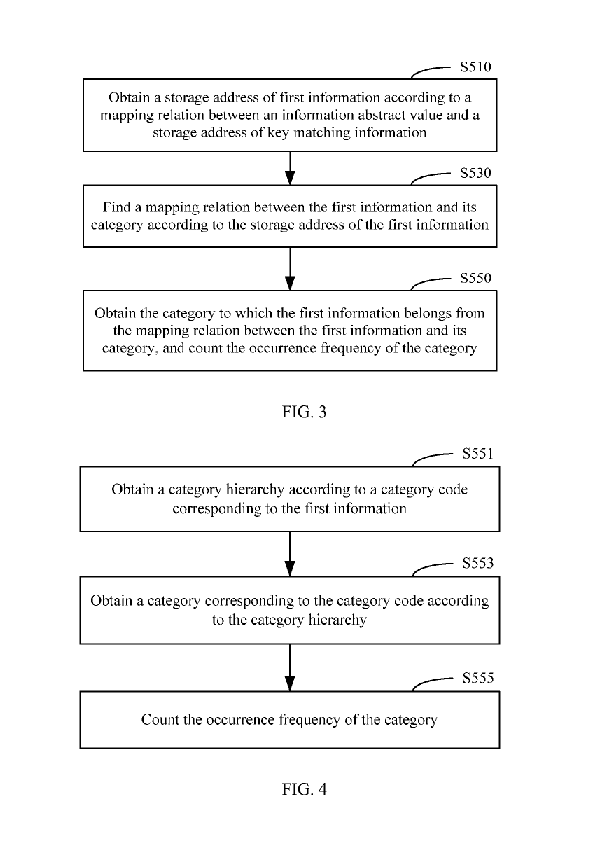

In an example, as shown in FIG. 3, the above block S50 includes the following specific process.

At block S510, the storage address of the first information is obtained according to the mapping relation between the information abstract value and the storage address of the key matching information.

At block S530, the mapping relation between the first information and the category is found according to the storage address of the first information.

In the present example, the mapping relation between the key matching information and the category to which it belongs is stored in advance. For example, if the key matching information is a singer's name, then its corresponding category may be music; if the key matching information is a movie's name, its corresponding category may be film & TV entertainment; if the key matching information is an image expression of smile, then its corresponding category may be smile. After the key matching information that is the same with the first information is obtained, the mapping relation between the first information and its corresponding category is obtained according to the storage address of the key matching information.

At block S550, the category to which the first information belongs is obtained from the mapping relation between the first information and its category, and the occurrence frequency of the category is counted.

In the present example, the category to which the first information belongs is obtained according to the searched mapping relation between the first information and its category, and the occurrence frequency of the category is increased by 1 to count the occurrence frequency of the category. The occurrence frequency represents a frequency at which a corresponding category occurs in one or multiple pieces of user behavior information.

In an example, a specific process of the above block S530 is that: searching the key matching information according to the storage address of the first information, and obtaining the mapping relation between the first information and a category code.

In the present example, in the mapping relation between the key matching information and the category to which it belongs, the category is stored in form of category code. That is, each category is numbered in advance. For example, the category of hot news may be numbered by 1, the category of film & TV entertainment may be numbered by 2, the category of fashion may be numbered by 3, and the category of game may be numbered by 5 . . . .

As shown in FIG. 4, a specific process of the above block S550 is as follows.

At block S551, a category hierarchy is obtained according to the category code corresponding to the first information.

In the present example, according to actual needs, the categories for the key matching information are defined roughly or in detail. A category hierarchy of one or more layers is set in advance and category coding is used to represent corresponding category layers. In the category coding, the codes for respective category layers are continuous and the codes corresponding to each category layer can be determined according to corresponding coding length. Specifically, the category codes can be represented in a hexadecimal form and are arranged from high-to-low bits according to a large-to-small order of the category hierarchy. For example, there are two layers in a category code, and the code length is 4 bytes. The code length corresponding to the first category layer is 1 byte, and the code length corresponding to the second category layer is 3 bytes. The key matching information is categorized according to a large category and small categories beneath the large category. The category code of 1 byte corresponding to the large category occupies a high bit, and the category code of a small category corresponding to the key matching information occupies a lower bit. And if the key matching information is a song's name, then the small category corresponding to the song's name is a singer's name with the category code being 0x010203, and if the large category is music, the category code is 9 and the corresponding hexadecimal category code is 0x09, then the category code corresponding to the key matching information is 0x09010203. At this point, the category layer of the key matching information can be determined by viewing the category code.

At block S553, the category corresponding to the category code is obtained according to the category layer.

In the example, the category corresponding to the category code of every category layer is obtained according to the category hierarchy. For example, according to the category code 0x09010203, it can be known that the first information has two category layers. The first category layer is 0x09 and the corresponding category is music, and the second category layer is 0x010203 and the corresponding category is the

At block S555, the occurrence frequency of the category is counted.

In the present example, when the category to which the first information belongs is obtained, the category should be counted to update the occurrence frequency corresponding to the category.

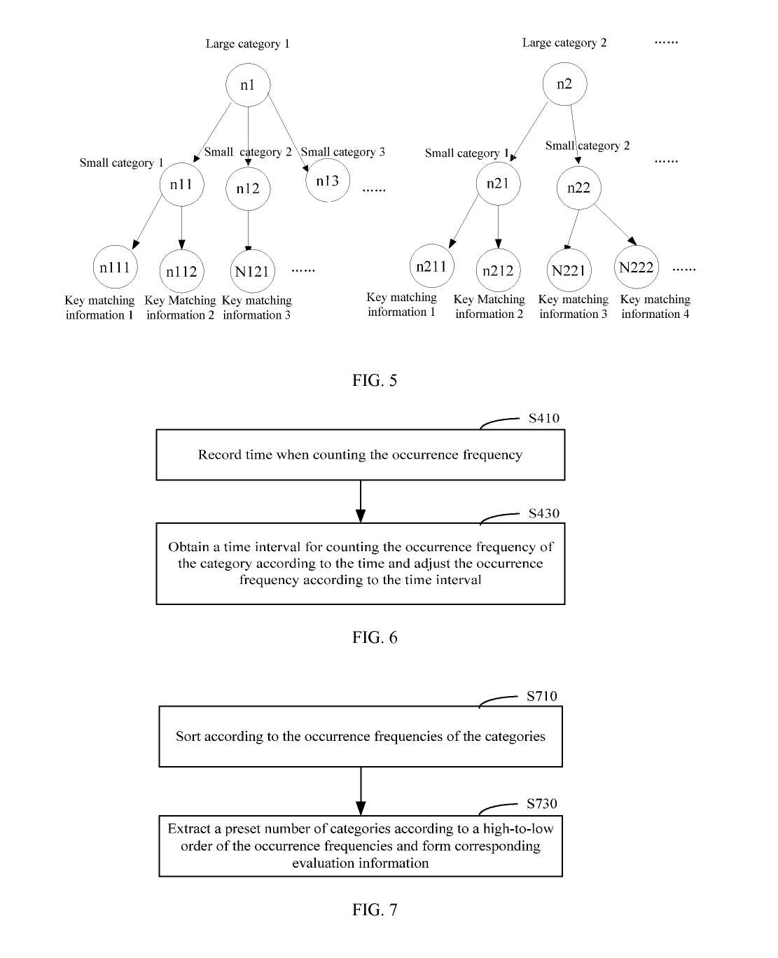

Furthermore, as shown in FIG. 5, according to the obtained category and the category hierarchy, a mapping relation is established between the category to which each category hierarchy belongs and the first information. For example, for a mapping relation in which the first information is a song's name, the large category is music, and the small category is a singer's name, the corresponding occurrence frequency should be labeled in the mapping relation to improve the efficiency of the subsequent process.

In another example, after the block of counting the occurrence frequency of the category the method further includes the following process.

The user behavior information is scanned to determine whether emotion phrases related to the first information exist therein, and if yes, the occurrence frequency of the category is adjusted according to the emotion phrases, or otherwise, the process ends.

In the present example, the user behavior information is scanned to see whether emotion phrases exist near to the first information, and the occurrence frequency of the first information is adjusted according to the emotion phrases. The emotion phrases can be phrases such as “like”, “love”, and “dislike”, etc., which include positive emotion phrases and negative emotion phrases. The positive emotion phrases are phrases such as “like”, “love”, etc., and the negative emotion phrases are phrases such as “disgust”, “dislike”, etc. Specifically, if an emotion phrase is a positive emotion phrase, then the occurrence frequency of the category is multiplied by a first coefficient, and the first coefficient is larger than 1; if an emotion phrase is a negative phrase, then the occurrence frequency of the category is multiplied by a second coefficient, and the second coefficient is smaller than −1. When the occurrence frequency of the category is adjusted according to the emotion phrases, the accuracy of the evaluation information obtained from the user behavior information is highly improved.

In another example, as shown in FIG. 6, after the block of counting the occurrence frequency of the category the method further includes the following process.

At block S410, the time when the occurrence frequency is counted is recorded.

At block S430, a time interval for counting the occurrence frequency of the category are obtained according to the time and the occurrence frequency of the category is adjusted according to the time interval.

In the present example, since the level of the occurrence frequency of certain key matching information can reflect the hot extent represented by the key matching information in the user behavior information. For example, in the user behavior information, if the first information “football” occurs several times in a short period, then it means that football is a hot phrase for the user who publishes the user behavior information, thus the occurrence frequency of the category corresponding to the “football” can be increased properly. Specifically, a threshold range where the time interval for counting the occurrence frequency of the category is located is obtained. The threshold range includes a first threshold and a second threshold which is larger than the first threshold. And the occurrence frequency is multiplied by a third coefficient according to the obtained threshold range to get a new occurrence frequency, in which the amount of the third coefficient is determined by the obtained threshold range and it may be a multiple of the first threshold. For example, if the time interval is between 1 and 2, then the occurrence frequency is multiplied by a constant, and if the time interval is between 2 and 3, then the occurrence frequency is multiplied by two times of the constant, and so on.

In another example, as shown in FIG. 7, the detailed process of the above block S70 is as follows.

At block S710, sort according to the occurrence frequencies of categories.

In the present example, according to the occurrence frequencies of categories, the categories are sorted to obtain several categories with a relatively high occurrence frequency.

At block S730, a preset number of categories are extracted according to a high-to-low order of the occurrence frequencies, and corresponding evaluation information is generated.

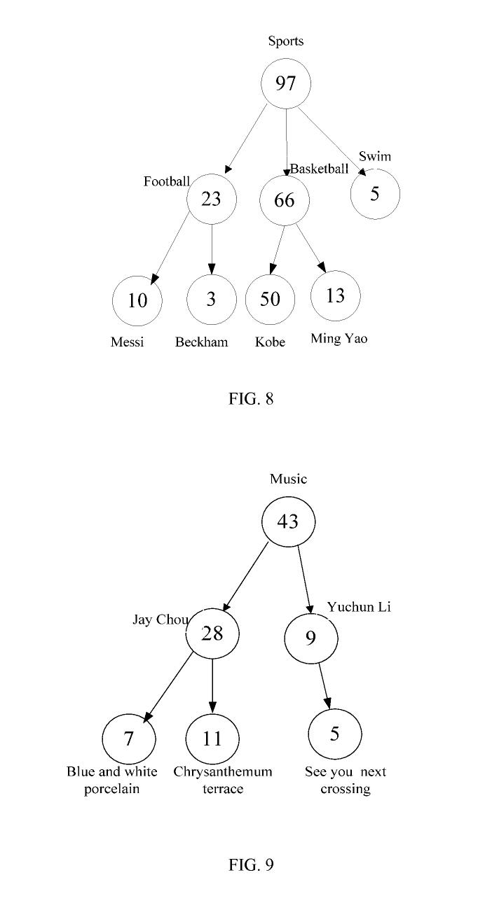

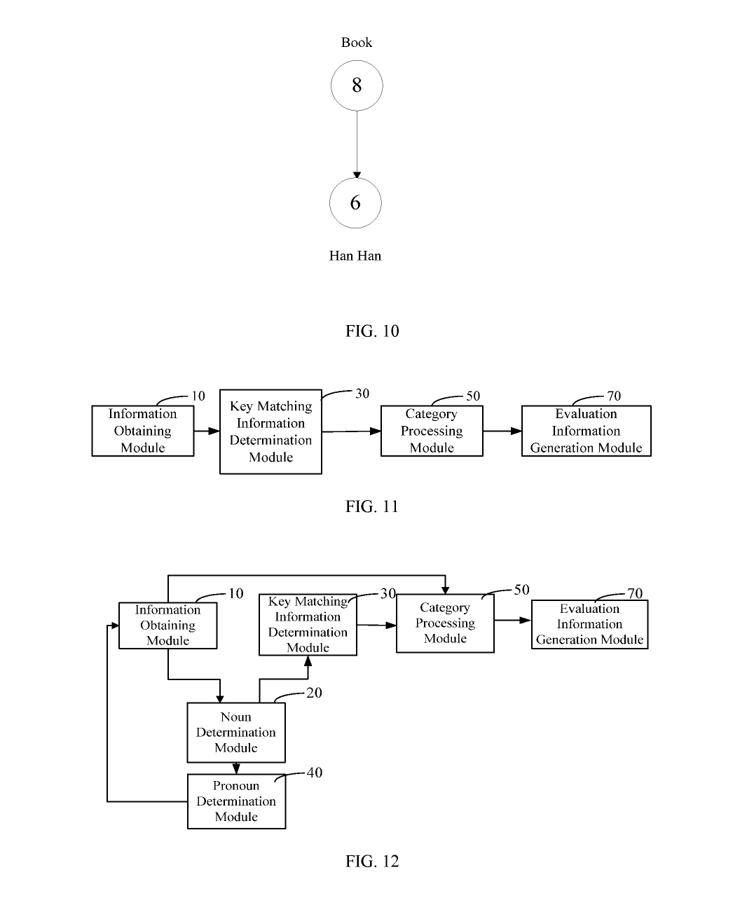

In the present example, evaluation information is generated for the categories with a high occurrence frequency. For example, as shown in FIG. 8 to FIG. 10, categories of sports, music and book have a relatively high occurrence frequency, then evaluation information labeled with “sports”, “music”, and “book” is generated. In addition, corresponding evaluation information can be generated according to small categories in the mapping relation.

According to evaluation information formed dynamically, common interests and hobbies of users and their friends as well as hotspot information can be understood accurately during the session by using instant communication tools, respective interests and hobbies of some user or its friend, the information and interests and hobbies concerned by users in virtual community website can also be obtained. In addition, according to evaluation information formed dynamically, network information can be sent to users who are interested in the information, according to same evaluation information existing among a plurality of users, friends who have same interests and hobbies and are concerned about same information shall be recommended to a user, which greatly increases the accuracy and effectiveness of evaluation on users and friends.

In an example, as shown in FIG. 11, a system for generating evaluation information includes: an information obtaining module 10, a key matching information determination module 30, a category processing module 50, and an evaluation information generation module 70.

The information obtaining module 10 obtains the first information from the user behavior information.

In the present example, the user behavior information may be session contents generated during sessions by using a social network tool such as an instant messaging tool, or may be information in websites such as blogs, microblogs, virtual communities, etc. Specifically, the user behavior information can be represented in the forms of text, pictures, and expressions used by users and the like. The first information may be a part or all of contents in the user behavior information. For example, if the user behavior information is in the form of text, the first information can be phrases in the user behavior information. If the user behavior information is picture information generated by an instant messaging tool in a session process, the first information can be an identification number corresponding to the picture information or other forms of identifications.

In an example, the user behavior information is text information, and the information obtaining module 10 also reads the user behavior information and performs word segmentation for the user behavior information to obtain the first information.

In the present example, the text information may be phrases, or may be multiple paragraphs of text consisting of a plurality of phrases. Therefore, in order to make analysis of the text information, the word segmentation needs to be performed by the information obtaining module 10 for the text information that has been read, and the result obtained by the word segmentation is the first information. Specifically, the first information may be a single phrase, or may be various nouns, pronouns and so on in the text information that has been read.

In an example, as shown in FIG. 12, the above system for generating evaluation information further includes a noun determination module 20, to determine whether the first information is a noun, and if yes, then notify the key matching information determination module 30, or not, then notify the pronoun determination module 40.

In the present example, in the scenario that the user behavior information is text information, the noun determination module 20 determines whether the first information obtained by the word segmentation process is a noun. And if the first information is a noun, then it is further determined whether the first information matches the key matching information. If the first information matches a certain keyword in the key matching information, it means that the first information is valid information and can be used to dynamically adjust the evaluation information.

The pronoun determination module 40 determines whether the first information is a pronoun, if yes, then informs the information obtaining module 10, or otherwise, ends the process.

In the present example, if the noun determination module 20 determines that the first information is not a noun, the pronoun determination module 40 further needs to determine whether the first information is a pronoun, and to see the pronoun refers to which first information in the user behavior information and then proceed with subsequent processes according to the determined first information. If the pronoun does not refer to any first information in the user behavior information, then the process for the first information ends and a process for another first information in the user behavior information is entered, or if the first information is already the last first information in the user behavior information, the process for the user behavior information will end, and other user behavior information will be processed accordingly, the detailed process of which will not be elaborated herein.

In an example, the information obtaining module 10 further obtains key matching information corresponding to the first information in the last determination and informs the category processing module 50.

In the present example, in the scenario that it is determined that the first information is a pronoun, the information obtaining module 10 obtains the key matching information that conforms to the first information in the last determination process for the first information, and further notifies the category processing module 50 to obtain the category it belongs according to the key matching information.

The key matching information determination module 30 determines whether the first information matches the key matching information, and if yes, it notifies the category processing module 50, or otherwise, the process ends.

In the present example, a plurality of key matching information is stored in advance so that certain key matching information that matches the first information can be found from the stored plurality of key matching information. For example, the key matching information may be a keyword, or may be an identification number of a picture.

The category processing module 50 obtains the category to which the key matching information corresponding to the first information belongs.

In the present example, the mapping relations between the key matching information and categories are established in advance. After the key matching information corresponding to the first information is obtained, the category processing module 50 obtains the category corresponding to the key matching information according to the established mapping relations.

Specifically, the mapping relations between the key matching information and the categories can be in the form of data dictionary, and a data structure corresponding thereto can be a mapping table with form of expression as map<key, value>, in which each key value has a uniquely corresponding value, key matching information is a key value, and a category is a value.

An evaluation information generation module 70 generates evaluation information according to the category.

In the present example, according to a category corresponding to each piece of the first information in the user behavior information, the evaluation information generation module 70 obtains evaluation information corresponding to the category. That is, the evaluation information corresponding to the user behavior information varies as the contents in the user behavior information vary. Thus, through processing user behavior information generated in a session by using an instant messaging tool or through processing user behavior information generated in a website such as a virtual network community, dynamic change of evaluation information is achieved to accurately reflect current user behavior information. Specifically, the evaluation information, which is generated according to the category to which the first information in the user behavior information belongs, can be used to reflect interests and hobbies, hotspot information, mood and the like of the user or of the friend.

In an example, a mapping relation between an information abstract value and a storage address of the key matching information is established.

In the example, the storage address is an address where the key matching information is in a data dictionary, and it may be in the form of a memory address, so as to perform searching in the key matching information according to the first information rapidly. The information abstract value of the key matching information can be a hash value calculated in text information through md5, SHA or other algorithms, and may also be an identification number in picture information. In the mapping relation between the information abstract value and the storage address of the key matching information, the corresponding mapping table structure can be such that the key matching information is a key value, while the storage address is a value.

The key matching information determination module 30 further searches in the mapping relation between the information abstract value and the memory address of the key matching information, determines whether the information abstract value corresponding to the first information exists in the information abstract value of the key matching information, and if yes, informs the category processing module 50, or if not, ends the process.

In the present example, the key matching information determination module 30 obtains the information abstract value of the first information and searches in the mapping relation between the information abstract value and the storage address of the key matching information to find out an information abstract value of the key matching information that is the same with the information abstract value of the first information to further obtain the storage address corresponding thereto.

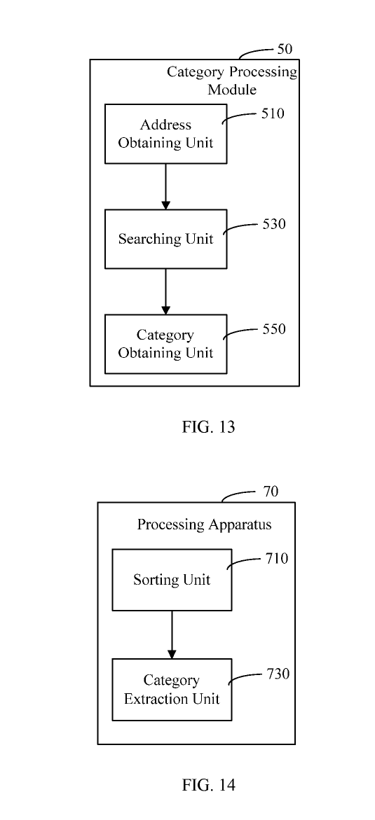

In an example, as shown in FIG. 13, the category processing module 50 includes an address obtaining unit 510, a searching unit 530 and a category obtaining unit 550.

The address obtaining unit 510 obtains the storage address of the first information according to the mapping relation between the information abstract value and the storage address of the key matching information.

The searching unit 530 searches the mapping relation between the first information and the category according to the storage address of the first information.

In the present example, the mapping relation between the key matching information and the category to which it belongs is stored in advance. For example, if the key matching information is a singer's name, then its corresponding category may be music; if the key matching information is a movie's name, its corresponding category may be film & TV entertainment; if the key matching information is an image expression of smile, then its corresponding category may be smile. After the key matching information that is the same with the first information is obtained, the searching unit 530 obtains the mapping relation between the first information and its corresponding category according to the storage address of the key matching information.

The category obtaining unit 550 obtains the category to which the first information belongs according to the mapping relation between the first information and its category, and counts the occurrence frequency of the category.

In the present example, the category obtaining unit 550 obtains the category to which the first information belongs according to the searched mapping relation between the first information and its category, and the occurrence frequency of the category is increased by 1, to count the occurrence frequency of the category. The occurrence frequency represents a frequency at which a corresponding category occurs in one or multiple pieces of user behavior information.

In another example, the category obtaining unit 550 further scans and determines whether emotion phrases related to the first information exists in the user behavior information, and if yes, adjusts the occurrence frequency of this category according to the emotion phrases, if not, ends the process.

In the present example, the category obtaining unit 550 scans the user behavior information to see whether emotion phrases exist near to the first information, and adjusts the occurrence frequency of the first information according to the emotion phrases. The emotion phrases can be phrases such as “like”, “love”, “dislike”, etc., which include positive emotion phrases and negative emotion phrases. The positive emotion phrases are phrases such as “like”, “love”, etc., and the negative emotion phrases are phrases such as “disgust”, “dislike”, etc. Specifically, if an emotion phrase is a positive emotion phrase, then the category obtaining unit 550 multiplies the occurrence frequency of the category by a first coefficient, and the first coefficient is larger than 1; if an emotion phrase is a negative phrase, then the category obtaining unit 550 multiplies the occurrence frequency of the category by a second coefficient, and the second coefficient is smaller than −1. The category obtaining unit 550 adjusts the occurrence frequency of the category according to the emotion phrases; the accuracy of the evaluation information obtained from the user behavior information is highly improved.

In another example, the category obtaining unit 550 records the time for counting the occurrence frequency, obtains a time interval for counting the occurrence frequency of the category according to the time, and adjusts the occurrence frequency of the category according to the time interval.

In the present example, since the level of the occurrence frequency of certain key matching information can reflect the hot extent represented by the key matching information in the user behavior information. For example, in the user behavior information, if the first information “football” appears multiple times within a short period, which means that football is a hot phrase for the user who issues the user behavior information, thus the category obtaining unit 550 may appropriately adjust the occurrence frequency of the category corresponding to “football”. Specifically, the category obtaining unit 550 obtains a threshold range where the time interval for counting the occurrence frequency of the category are located is obtained. The threshold range includes a first threshold and a second threshold which is larger than the first threshold. And the occurrence frequency is multiplied by a third coefficient according to the obtained threshold range to get a new occurrence frequency, in which the amount of the third coefficient is determined by the obtained threshold range, and it may be a multiple of the first threshold. For example, if the time interval is between 1 and 2, then the occurrence frequency is multiplied by a constant; if the time interval is between 2 and 3, then the occurrence frequency is multiplied by two times of the constant, and so forth.

In another example, the searching unit 530 searches the key matching information according to the storage address of the first information, and obtains a mapping relation between the first information and a category code.

In the present example, in the mapping relation between the key matching information and its category, the category is stored in form of category code. That is, each category is numbered in advance. For example, the category of hot news may be numbered by 1, the category of film & TV entertainment may be numbered by 2, the category of fashion may be numbered by 3, and the category of game may be numbered by 5

The category obtaining unit 550 obtains a category hierarchy according to the category code to which first information corresponds, obtains a category corresponding to category code according to category hierarchy, and count the occurrence frequency of the category.

In the present example, according to actual needs, the categories for the key matching information are defined roughly or in detail. A category hierarchy of one or more layers is set in advance and category coding is used to represent corresponding category layers. In the category coding, the codes for respective category layers are continuous and the code corresponding to each category layer can be determined according to corresponding coding length. Specifically, the category codes can be represented in a hexadecimal form and are arranged from high-to-low bits according to a large-to-small order of the category hierarchy. For example, there are two layers in a category code, and the code length is 4 bytes. The code length corresponding to the first category layer is 1 byte, and the code length corresponding to the second category layer is 3 bytes. The key matching information is categorized according to a large category and small categories beneath the large category. The category code of 1 byte corresponding to the large category occupies a high bit, and the category code of a small category corresponding to the key matching information occupies a low bit. And if the key matching information is a song's name, then the small category corresponding to the song's name is a singer's name with the category code being 0x010203, and if the large category is music and the category code is 9 and the corresponding hexadecimal category code is 0x09, then the category code corresponding to the key matching information is 0x09010203. At this point, the category layer of the key matching information can be determined by viewing the category code.

The category obtaining unit 550 obtains the category corresponding to the category code of each category layer according to the category hierarchy, when the category to which the first information belongs is obtained, should also count the category to update the occurrence frequency corresponding to the category. For example, according to the category code 0x09010203, it can be known that the first information has two category layers. The first category layer is 0x09 and the corresponding category is music, and the second category layer is 0x010203 and the corresponding category is a singer's name.

Furthermore, as shown in FIG. 5, according to the obtained category and the category hierarchy, the mapping relation is established between the category to which each category hierarchy belongs and the first information. For example, if the first information is a song's name, its large category is music, and its small category is a singer's name, the corresponding occurrence frequency should be labeled in the mapping relation to improve the efficiency of the subsequent process.

In an example, as shown in FIG. 14, the evaluation information generation module 70 includes a sorting unit 710 and a category extraction unit 730.

The sorting unit 710 sorts according to the occurrence frequencies of categories.

In the present example, the sorting unit 710 sorts the categories according to the occurrence frequencies of categories, to obtain multiple categories with a relatively high occurrence frequency.

The category extraction unit 730 extracts a preset number of categories according to a high-to-low order of the occurrence frequencies, and generates corresponding evaluation information.

In the present example, the category extraction unit 730 generates evaluation information for the categories with a high occurrence frequency. Categories of sports, music and book have a relatively high occurrence frequency, the category extraction unit 730 generates evaluation information labeled with “sports”, “music”, and “book”; in addition, the category extraction unit 730 generates corresponding evaluation information according to small categories in the mapping relation.

The method and system for generating evaluation information, and a corresponding computer storage medium, obtain the first information from the user behavior information, and obtain a corresponding category according to the first information which matches with the preset key matching information, thus generating evaluation information corresponding to the category. The generated evaluation information varies as the first information varies, and dynamic adjustment of evaluation information is achieved.

The invention also provides a computer storage medium which is used to store computer executable instructions. The computer executable instructions are used to control a computer to implement a method for interaction in the touch terminal, the computer executable instructions in the computer storage medium execute specific steps for interaction in the touch terminal, as described in the above methods, which will not be elaborated hereinafter.

The foregoing description, for purpose of explanation, has been described with reference to specific examples. However, the illustrative discussions above are not intended to be exhaustive or to limit the present disclosure to the precise forms disclosed. Many modifications and variations are possible in view of the above teachings. The examples were chosen and described in order to best explain the principles of the present disclosure and its practical applications, to thereby enable others skilled in the art to best utilize the present disclosure and various examples with various modifications as are suited to the particular use contemplated.

1. A method for generating evaluation information, comprising the following steps:
obtaining first information from user behavior information;
determining whether the first information matches key matching information, and if yes, then obtaining a category to which the key matching information corresponding to the first information belongs; and
generating evaluation information according to the category
wherein before the step of determining whether the first information matches the key matching information, the method further comprises:
establishing a mapping relation between an information abstract value and a storage address of the key matching information; and
the step of determining whether the first information matches the key matching information comprises: searching in the mapping relation between the information abstract value and the storage address of the key matching information and determining whether an information abstract value corresponding to the first information exists in the information abstract value of the key matching information, and if yes, then
in the step of obtaining the category to which the key matching information belongs according to the key matching information corresponding to the first information:
obtaining a storage address of the first information according to the mapping relation between the information abstract value and the storage address of the key matching information;
searching a mapping relation between the first information and the category according to the storage address of the first information; and
obtaining the category to which the first information belongs according to the mapping relation between the first information and the category and counting an occurrence frequency of the category.

2. The method for generating evaluation information according to claim 1, wherein if the user behavior information is text information, then the step of obtaining the first information from the user behavior information further comprises:
reading the user behavior information and performing word segmentation for the user behavior information to obtain the first information; and
if the user behavior information is picture information, then obtaining the first information from the user behavior information further comprises:
obtaining the first information corresponding to the picture information, the first information being an identification number.

3. (canceled)

4. The method for generating evaluation information according to claim 1, wherein the step of searching the mapping relation between the first information and the category according to the storage address of the first information comprises:
searching the key matching information according to the storage address of the first information and obtaining a mapping relation between the first information and a category code;
the step of obtaining the category to which the first information belongs according to the mapping relation between the first information and the category and counting the occurrence frequency of the category comprises:
obtaining a category hierarchy according to the category code corresponding to the first information;
obtaining the category corresponding to the category code according to the category hierarchy; and
counting the occurrence frequency of the category.

5. The method for generating evaluation information according to claim 4, wherein after the step of counting the occurrence frequency of the category, the method further comprises:
according to the obtained category and the category hierarchy, establishing a mapping relation between a category to which each category hierarchy belongs and the first information, and labeling the corresponding occurrence frequency in the mapping relation.

6. The method for generating evaluation information according to claim 1, wherein the step of generating the evaluation information according to the category comprises:
sorting according to occurrence frequencies of categories; and
extracting a preset number of categories according to a high-to-low order of the occurrence frequencies, and generating the corresponding evaluation information.

7. The method for generating evaluation information according to claim 1, wherein after the step of counting the occurrence frequency of the category, the method further comprises:
scanning and determining whether the user behavior information contains an emotion phrase related to the first information, and if yes, adjusting the occurrence frequency of the category according to the emotion phrase.

8. The method for generating evaluation information according to claim 1, wherein after the step of counting the occurrence frequency of the category, the method further comprises:
recording time for counting the occurrence frequency; and
obtaining a time interval for counting the occurrence frequency of the category according to the time, and adjusting the occurrence frequency of the category according to the time interval.

9. The method for generating evaluation information according to claim 2, further comprising:
before the step of determining whether the first information matches the preset key matching information the method further comprising:
determining whether the first information is a noun, and if yes, entering the step of determining whether the first information matches the key matching information, and if not, then
further determining whether the first information is a pronoun, and if yes, then
obtaining the key matching information corresponding to the first information in last determination, and entering the step of obtaining a category to which the noun belongs according to the key matching information corresponding to the first information.

10. A system for generating evaluation information, comprising:
an information obtaining module, to obtain first information from user behavior information;
a key matching information determination module, to determine whether the first information matches key match information, and if yes, to notify a category processing module;
the category processing module, to obtain a category to which the key matching information corresponding to the first information belongs; and
an evaluation information generation module, to generate evaluation information according to the category;
wherein, a mapping relation between an information abstract value and a storage address of the key matching information is established in advance;
the key matching information determination module further searches in the mapping relation between the information abstract value and the storage address of the key matching information, and determining whether an information abstract value corresponding to the first information exists in the information abstract value of the key matching information, and if yes, then informs the category processing module;
the category processing module comprises:
an address obtaining unit, to obtain a storage address of the first information according to the mapping relation between the information abstract value and the storage address of the key matching information;
a searching unit, to search a mapping relation between the first information and the category according to the storage address of the first information; and
a category obtaining unit, to obtain the category to which the first information belongs according to the mapping relation between the first information and the category and counting an occurrence frequency of the category.

11. The system for generating evaluation information according to claim 10, wherein, if the user behavior information is text information, the information obtaining module reads the user behavior information and performs word segmentation for the user behavior information to obtain the first information; and
if the user behavior information is picture information, the information obtaining module obtains the first information corresponding to the picture information, and the first information is an identification number.

12. (canceled)

13. The system for generating evaluation information according to claim 10, wherein, the category obtaining unit is further to establish a mapping relation between a category to which each category hierarchy belongs and the first information according to the obtained category and the category hierarchy, and label the corresponding occurrence frequency in the mapping relation.

14. The method for generating evaluation information according to claim 10, wherein,
the searching unit is further to search the key matching information according to the storage address of the first information and obtain a mapping relation between the first information and a category code; and
the category obtaining unit is further to obtain a category hierarchy according to the category code corresponding to the first information, obtain the category corresponding to the category code according to the category hierarchy, and count the occurrence frequency of the category.

15. The method for generating evaluation information according to claim 10, wherein the evaluation information generation module comprises:
a sorting unit, to sort according to the occurrence frequency of categories; and
a category extraction unit, to extract a preset number of categories according to a high-to-low order of occurrence frequencies, and generate corresponding evaluation information.

16. The method for generating evaluation information according to claim 10, wherein the category processing module further comprises:
a scanning unit, to scan whether the user behavior information contains an emotion phrase related to the first information, and if yes, notify a first frequency adjustment unit; and
the first frequency adjustment unit, to adjust the occurrence frequency of the category according to the emotion phrase.

17. The method for generating evaluation information according to claim 10, wherein the category processing module further comprises:
a recording unit, to record time for counting the occurrence frequency; and
a second frequency adjustment unit, to obtain a time interval for counting the occurrence frequency of the category according to the time, and adjust the occurrence frequency of the category according to the time interval.

18. The system for generating evaluation information according to claim 11, further comprising:
a noun determination module, to determine whether the first information is a noun, if yes, notify the key matching information determination module, if not, notify a pronoun determination module;
the pronoun determination module is to further determine whether the first information is a pronoun, if yes, notify an information obtaining module; and
the information obtaining module is further to obtain the key matching information corresponding to the first information, and notify the category processing module.

19. (canceled)

19. A computer storage medium which is used to store computer executable instructions, the computer executable instructions are used to control a computer to implement a method for providing evaluation information, wherein the method comprises:
obtaining first information from user behavior information;
determining whether the first information matches key matching information, and if yes, then obtaining a category to which the key matching information corresponding to the first information belongs; and
generating evaluation information according to the category.
